(19) United States
(12) Patent Application Publication
(10) Pub. No.: US 2008/0273452 A1
(43) Pub. Date: Nov. 6, 2008

(54) Antenna mapping in a MIMO wireless communication system

(76) Inventors: Farooq Khan, Allen, TX (US); Jiann-An Tsai, Plano, TX (US); Jianzhong Zhang, Irving, TX (US); Yinong Ding, Plano, TX (US)

Correspondence Address: ROBERT E. BUSHNELL, 1522 K STREET NW, SUITE 300, WASHINGTON, DC, 20005-1202, US

(21) Appl. No.: 12/007,586

(22) Filed: Jan. 11, 2008

Related U.S. Application Data
(60) Provisional application No. 60/924,222, filed on May 4, 2007.

(51) Int. Cl. H04B 7/00

(52) U.S. Cl. 370/203; 370/310

(57) ABSTRACT

A method for transmission is provided to generate a plurality of reference signals for a plurality of antenna ports, with each reference signal corresponding to an antenna port; to map the plurality of reference signals to a plurality of physical antennas in accordance with a selected antenna port mapping scheme, with each reference signal corresponding to a physical antenna, and the plurality of physical antennas being aligned sequentially with equal spacing between two immediately adjacent physical antennas; to demultiplex information to be transmitted into a plurality of stream blocks; to insert a respective cyclic redundancy check to each of the stream blocks; to encode each of the stream blocks according to a corresponding coding scheme; to modulate each of the stream blocks according to a corresponding modulation scheme; to demultiplex the stream blocks to generate a plurality of sets of symbols, with each stream block being demultiplexed into a set of symbols; to map the plurality of sets of symbols into the plurality of antenna ports in accordance with a selected symbol mapping scheme; and to transmit the plurality of sets of symbols via the corresponding antenna ports, with each set of symbols being transmitted via a subset of antenna ports, with, within each subset of antenna ports, the distance between the physical antennas of the corresponding antenna ports being larger than the average distance among the plurality of physical antennas.

### CLAIM OF PRIORITY

This application makes reference to, incorporates the same herein, and claims all benefits accruing under 35 U.S.C. §119 from a provisional application earlier filed in the U.S. Patent & Trademark Office on 4 May 2007 and there duly assigned Ser. No. 60/924,222.

### BACKGROUND OF THE INVENTION

1. Field of the Invention

The present invention relates to a method for transmitting data in a communication system, and more specifically, a process and circuits for transmitting information by mapping antennas in a communication system.

2. Description of the Related Art

A typical cellular radio system includes a number of fixed base stations and a number of mobile stations. Each base station covers an geographical area, which is defined as a cell.

Typically, a non-line-of-sight (NLOS) radio propagation path exists between a base station and a mobile station due to natural and man-made objects disposed between the base station and the mobile station. As a consequence, radio waves propagate while experiencing reflections, diffractions and scattering. The radio wave which arrives at the antenna of the mobile station in a downlink direction, or at the antenna of the base station in an uplink direction, experiences constructive and destructive additions because of different phases of individual waves generated due to the reflections, diffractions, scattering and out-of-phase recombination. This is due to the fact that, at high carrier frequencies typically used in a contemporary cellular wireless communication, small changes in differential propagation delays introduces large changes in the phases of the individual waves. If the mobile station is moving or there are changes in the scattering environment, then the spatial variations in the amplitude and phase of the composite received signal will manifest themselves as the time variations known as Rayleigh fading or fast fading attributable to multipath reception. The time-varying nature of the wireless channel require very high signal-to-noise ratio (SNR) in order to provide desired bit error or packet error reliability.

The scheme of diversity is widely used to combat the effect of fast fading by providing a receiver with multiple faded replicas of the same information-bearing signal.

The schemes of diversity in general fall into the following categories: space, angle, polarization, field, frequency, time and multipath diversity. Space diversity can be achieved by using multiple transmit or receive antennas. The spatial separation between the multiple antennas is chosen so that the diversity branches, i.e., the signals transmitted from the multiple antennas, experience fading with little or no correlation. Transmit diversity, which is one type of space diversity, uses multiple transmission antennas to provide the receiver with multiple uncorrelated replicas of the same signal. Transmission diversity schemes can further be divided into open loop transmit diversity and closed-loop transmission diversity schemes. In the open loop transmit diversity approach no feedback is required from the receiver. In one type of closed loop transmit diversity, a receiver knows an arrangement of transmission antennas, computes a phase and amplitude adjustment that should be applied at the transmitter antennas in order to maximize a power of the signal received at the receiver. In another arrangement of closed loop transmit diversity referred to as selection transmit diversity (STD), the receiver provides feedback information to the transmitter regarding which antenna(s) to be used for transmission.

An example of open-loop transmission diversity scheme is the Alamouti 2×1 space-time diversity scheme. The Alamouti 2×1 space-time diversity scheme contemplates transmitting a Alamouti 2×2 block code using two transmission antennas using either two time slots (i.e., Space Time Block Code (STBC) transmit diversity) or two frequency subcarriers (i.e., Space Frequency Block Code (SFBC) transmit diversity).

One limitation of Alamouti 2×1 space-time diversity scheme is that this scheme can only be applied to two transmission antennas. In order to transmit data using four transmission antennas, a Frequency Switched Transmit Diversity (FSTD) or a Time Switched Transmit Diversity (TSTD) is combined with block codes.

The problem with combined SFBC+FSTD scheme and STBC+TSTD schemes is that only a fraction of the total transmission antennas and hence power amplifier capability is used for transmission in a given frequency or time resource. This is indicated by ‘0’ elements in the SFBC+FSTD and STBC+TSTD matrix given above. When the transmit power on the non-zero elements in the matrix is increased, bursty interference is generated to the neighboring cells degrading system performance. Generally, bursty interference manifests itself when certain phases of a frequency hopping pattern incur more interference than other phases.

In the Third Generation Partnership Project Long Term Evolution (3GPP LTE) system, the downlink reference signals mapping for four transmission antennas determines that a transmission density on the third antenna port and the fourth antenna port is half of the density on the first antenna port and the second antenna port. This leads to weaker channel estimates on the third and the fourth antenna ports.

Moreover, the antenna correlation depends upon, among other factors, angular spread and antennas spacing. In general, for a given angle spread, the larger the antenna spacing the smaller the correlation among the antennas. In a four transmission antenna 3GPP LTE system, the four antennas are usually aligned sequentially with equal spacing between two immediate antennas. Therefore, the correlation between the first antenna and the second antenna is larger than the correlation between the first antenna and the third antenna. Similarly, the correlation between the third antenna and the fourth antenna is larger than the correlation between the second antenna and the fourth antenna. Because smaller correlation among antennas means higher achievable diversity, this kind of antenna arrangement may result in degraded transmit diversity performance for the symbols transmitted via the first and the second antennas, and for the symbols transmitted via the third and the fourth antennas.

### SUMMARY OF THE INVENTION

It is therefore an object of the present invention to provide an improve method and an improved apparatus for transmitting information.

It is another object to provide an improve method and an improved apparatus for transmitting information in order to improve the transmission performance and increase the system throughput.

It is another object to provide an improve method and an improved apparatus for transmitting information in order to improve the transmission diversity performance.

According to on aspect of the present invention, a method and an apparatus may be provided to include demultiplexing information to be transmitted into a plurality of stream blocks; inserting a respective cyclic redundancy check to each of the stream blocks; encoding each of the stream blocks according to a corresponding coding scheme; modulating each of the stream blocks according to a corresponding modulation scheme; demultiplexing the stream blocks to generate a plurality of sets of symbols, with each stream block being demultiplexed into a set of symbols; and transmitting the plurality of symbols via a plurality of antenna ports, with each set of symbols being transmitted via a subset of the plurality of antenna ports, and the antenna ports having weaker channel estimates being equally distributed among the plurality of subsets of antenna ports.

When four symbols are transmitted via four antenna ports according to a transmission matrix where a first symbol and a second symbol are generated from a first stream block, a third symbol and a fourth symbol are generated from a second stream block, and the first and second antenna ports have higher channel estimates than the third and the fourth antenna ports, the transmission matrix may be expressed as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ]$$

where Tᵢⱼ represents symbol transmitted on the ith antenna port and the jth subcarrier or jth time slot, S₁, S₂, S₃, and S₄ represent the first through the fourth symbols respectively.

According to another aspect of the present invention, a method and an apparatus may be provided to include generating four reference signals for four antenna ports, with each reference signal corresponding to an antenna port; mapping the four antenna ports to four physical antennas in accordance with a selected antenna port mapping scheme, with each antenna port corresponding to a physical antenna, with the four physical antennas being aligned sequentially with equal spacing between two immediately adjacent physical antennas, and the channel estimates of the third and the fourth antenna ports are weaker than the channel estimates of the first and the second antenna ports; demultiplexing information to be transmitted into two stream blocks including a first stream block and a second stream block; inserting a respective cyclic redundancy check to each of the two stream blocks; encoding each of the two stream blocks according to a corresponding coding scheme; modulating each of the two stream blocks according to a corresponding modulation scheme; demultiplexing a first stream block into a first symbol and a second symbol and demultiplexing a second stream block into a third symbol and a fourth symbol; and transmitting the four symbols via the four antenna ports according to a selected transmission matrix.

The selected antenna port mapping scheme may be established such that a first antenna port is mapped to a first physical antenna, a second antenna port is mapped to a third physical antenna, a third antenna port is mapped to a second physical antenna, and a fourth antenna port is mapped to a fourth physical antenna. In this case, the transmission matrix may be established as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ]$$

where Tᵢⱼ represents the symbol transmitted on the ith antenna port and the jth subcarrier or jth time slot, S₁, S₂, S₃, and S₄ represent the first through the fourth symbols respectively.

Alternatively, the selected antenna port mapping scheme may be established such that a first antenna port is mapped to a first physical antenna, a second antenna port is mapped to a second physical antenna, a third antenna port is mapped to a third physical antenna, and a fourth antenna port is mapped to a fourth physical antenna. In this case, the transmission matrix may be established as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ]$$

where Tᵢⱼ represents the symbol transmitted on the ith antenna port and the jth subcarrier or jth time slot, S₁, S₂, S₃, and S₄ represent the first through the fourth symbols respectively.

According to yet another aspect of the present invention, a method and an apparatus may be provided to include generating a plurality of reference signals for a plurality of antenna ports, with each reference signal corresponding to an antenna port; mapping the plurality of antenna ports to a plurality of physical antennas in accordance with a selected antenna port mapping scheme, with each antenna port corresponding to a physical antenna, and the plurality of physical antennas being aligned sequentially with equal spacing between two immediately adjacent physical antennas; demultiplexing information to be transmitted into a plurality of stream blocks; inserting a respective cyclic redundancy check to each of the stream blocks; encoding each of the stream blocks according to a corresponding coding scheme; modulating each of the stream blocks according to a corresponding modulation scheme; demultiplexing the stream blocks to generate a plurality of sets of symbols, with each stream block being demultiplexed into a set of symbols; mapping the plurality of sets of symbols into the plurality of antenna ports in accordance with a selected symbol mapping scheme; and transmitting the plurality of sets of symbols via the corresponding antenna ports, with each set of symbols being transmitted via a subset of antenna ports, with, within each subset of antenna ports, the distance between the physical antennas of the corresponding antenna ports being larger than the average distance among the plurality of physical antennas.

When two stream blocks are transmitted via four antenna ports, the selected antenna port mapping scheme may be established such that a first antenna port is mapped to a first physical antenna, a second antenna port is mapped to a third physical antenna, a third antenna port is mapped to a second physical antenna, and a fourth antenna port is mapped to a fourth physical antenna. In this case, the selected symbol mapping scheme may be established such that a first stream block is mapped to the first and the second antenna ports, and a second stream block is mapped to the third and the fourth antenna ports.

Alternatively, when two stream blocks are transmitted via four antenna ports, the selected antenna port mapping scheme may be established such that a first antenna port is mapped to a first physical antenna, a second antenna port is mapped to a second physical antenna, a third antenna port is mapped to a third physical antenna, and a fourth antenna port is mapped to a fourth physical antenna. In this case, the selected symbol mapping scheme may be established such that a first stream block is mapped to the first and the third antenna ports, and a second stream block is mapped to the second and the fourth antenna ports, such that the third and the fourth antenna ports having weaker channel estimates are equally distributed between the first and the second stream blocks.

According to still another aspect of the present invention, a method and an apparatus may be provided to include demultiplexing information to be transmitted into a plurality of stream blocks; inserting a respective cyclic redundancy check to each of the stream 1I blocks; encoding each of the stream blocks according to a corresponding coding scheme; modulating each of the stream blocks according to a corresponding modulation scheme to generate a plurality of modulated symbols; dividing the plurality of modulated symbols into a plurality of groups of modulated symbols; selecting a subset of matrices from among six permuted versions of a selected Space Frequency Block Code matrix; repeatedly applying the selected set of matrices to the plurality of groups of modulated symbols to generate a plurality of transmit matrices, with each matrix corresponding to a group of modulated symbols and each matrix being applied to each pair of modulated symbols in the corresponding group of modulated symbols; and transmitting the plurality of transmit matrices via four transmission antennas using a plurality of subcarriers, with each transmit matrix using two subcarriers.

The selected Space Frequency Block Code diversity matrix may be a Space Frequency Block Code Cyclic Delay Diversity (SFBC-CDD) matrix, and the six permutated versions may be expressed as:

$${P}_{A} = [ \begin{matrix}{S}_{1} & - {S}_{2}^{*} \\ {S}_{2} & {S}_{1}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )}\end{matrix} ] , \\ {P}_{B} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] , \\ {P}_{C} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{D} = [ \begin{matrix}{S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{1} & - {S}_{2}^{*} \\ {S}_{2} & {S}_{1}^{*}\end{matrix} ] , \\ {P}_{E} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{F} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] ,$$

where S₁ and S₂ are two modulated symbols, g=[k/2] is the group index of two subcarriers, k is the subcarrier index, and functions b₁(g) and b₂(g) are two pseudo-random phase shift vectors that are functions of the subcarrier group index g.

Alternatively, the selected Space Frequency Block Code diversity matrix may be a Space Frequency Block Code Phase Switched Diversity (SFBC-PSD) matrix, and the six permutated versions may be expressed as:

$${C}_{A} = [ \begin{matrix}{S}_{1} & - {S}_{2}^{*} \\ {S}_{2} & {S}_{1}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}}\end{matrix} ] , \\ {C}_{B} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] , \\ {C}_{C} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{D} = [ \begin{matrix}{S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{1} & - {S}_{2}^{*} \\ {S}_{2} & {S}_{1}^{*}\end{matrix} ] , \\ {C}_{E} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{F} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] ,$$

where S₁ and S₂ are two modulated symbols, k is the subcarrier index, and θ₁ and θ₂ are two fixed phase angles.

According to a further aspect of the present invention, a method and an apparatus may be provided to include demultiplexing information to be transmitted into a plurality of stream blocks; inserting a respective cyclic redundancy check to each of the stream blocks; encoding each of the stream blocks according to a corresponding coding scheme; modulating each of the stream blocks according to a corresponding modulation scheme to generate a pair of modulated symbols; selecting a subset of matrices from among six permuted versions of a selected Space Frequency Block Code matrix; repeatedly transmitting the pair of symbols by applying the selected set of matrices to the pairs of modulated symbols, with each matrix being transmitted at a time slot.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying. drawings in which like reference symbols indicate the same or similar components, wherein:

FIG. 1 illustrates an Orthogonal Frequency Division Multiplexing (OFDM) transceiver chain;

FIG. 2 is an illustration of a Space Time Block Code transmission diversity scheme for two transmission antennas;

FIG. 3 is an illustration of another Space Frequency Block Code transmission diversity scheme for two transmission antennas;

FIG. 4 is an illustration of mapping of downlink reference signals in a contemporary 3^{rd} Generation Partnership Project Long Term Evolution system;

FIG. 5 illustrates an arrangement of four transmission antennas;

FIG. 6 is an illustration of a Multiple Input Multiple Output (MIMO) transceiver chain;

FIG. 7 illustrates a single codeword MIMO transmission scheme;

FIG. 8 illustrates a multiple codeword MIMO transmission scheme;

FIG. 9 illustrates a multiple codeword MIMO transmission scheme according to a first embodiment of the principles of the present invention;

FIG. 10 illustrates a reference symbol mapping scheme in case of four transmission antennas according to a second embodiment of the principles of the present invention;

FIG. 11 illustrates a multiple codeword MIMO mapping scheme according to a third embodiment of the principles of the present invention;

FIG. 12 illustrates a reference symbol mapping scheme in case of four transmission antennas according to a fourth embodiment of the principles of the present invention; and

FIG. 13 illustrates a multiple codeword MIMO mapping scheme according to a fifth embodiment of the principles of the present invention.

### DETAILED DESCRIPTION OF THE INVENTION

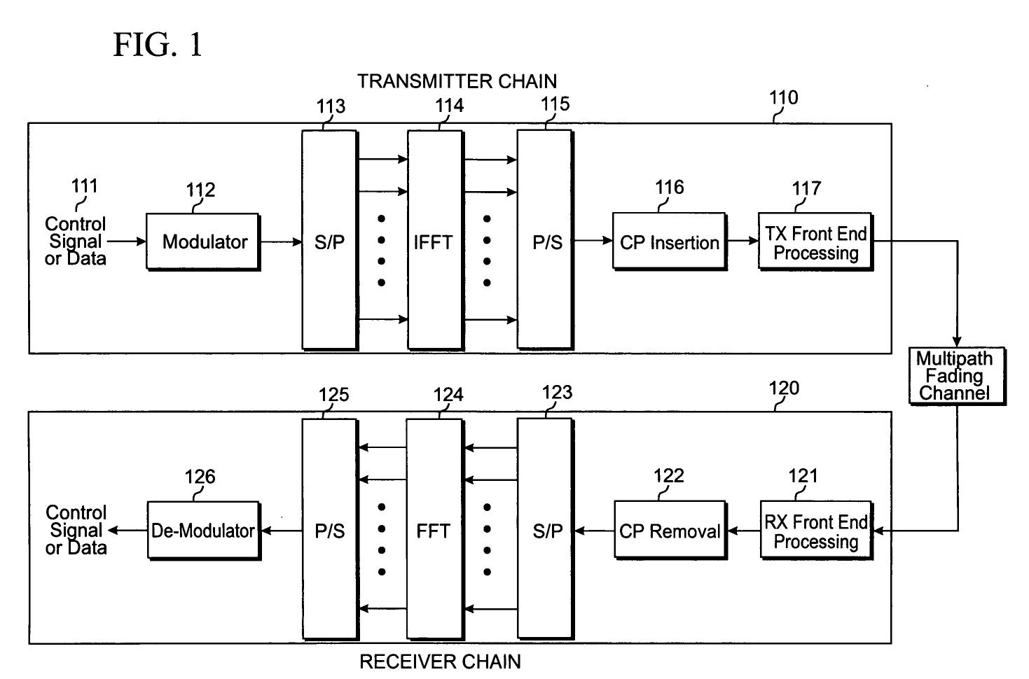

FIG. 1 illustrates an Orthogonal Frequency Division Multiplexing (OFDM) transceiver chain. In a communication system using OFDM technology, at transmitter chain 110, control signals or data 111 is modulated by modulator 112 and is serial-to-parallel converted by Serial/Parallel (S/P) converter 113. Inverse Fast Fourier Transform (IFFT) unit 114 is used to transfer the signal from frequency domain to time domain. Cyclic prefix (CP) or zero prefix (ZP) is added to each OFDM symbol by CP insertion unit 116 to avoid or mitigate the impact due to multipath fading. Consequently, the signal is transmitted by transmitter (Tx) front end processing unit 117, such as an antenna (not shown), or alternatively, by fixed wire or cable. At receiver chain 120, assuming perfect time and frequency synchronization are achieved, the signal received by receiver (Rx) front end processing unit 121 is processed by CP removal unit 122. Fast Fourier Transform (FFT) unit 124 transfers the received signal from time domain to frequency domain for further processing.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

The scheme of diversity is widely used to combat the effect of fast fading by providing a receiver with multiple faded replicas of the same information-bearing signal.

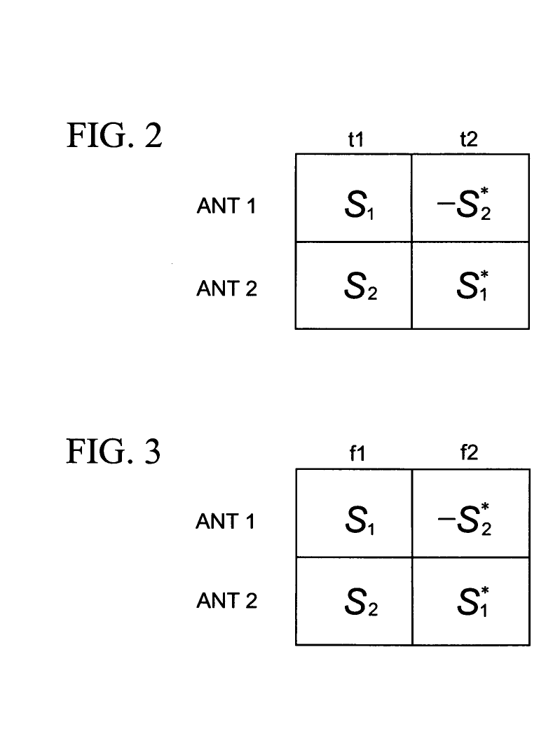

An example of open-loop transmission diversity scheme is the Alamouti 2×1 space-time block code (STBC) transmission diversity scheme as illustrated in FIG. 2. In this approach, during any symbol period, i.e., time period, a transmitter transmits two data symbols via two transmission antennas to a receiver. As shown in FIG. 2, during the first symbol interval t1, symbols S₁ and S₂ are respectively transmitted via antennas ANT 1 and ANT 2. During the next symbol period t2, symbols −S*₂ and S*₁ are respectively transmitted via antennas ANT 1 and ANT 2, where x* represents complex conjugate of x. After receiving the signals, the receiver performs a plurality of processes to recover original symbols S₁ and S₂. Note that the instantaneous channel gains g1 and g2 for ANT 1 and ANT 2, respectively, are required for processing at the receiver. Therefore, the transmitter needs to transmit separate pilot symbols via both the antennas ANT 1 and ANT 2 for channel gain estimation at the receiver. The diversity gain achieved by Alamouti coding is the same as that achieved in Maximum Ratio Combining (MRC).

The 2×1 Alamouti scheme can also be implemented in a space-frequency block code (SFBC) transmission diversity scheme as illustrated in FIG. 3. As shown in FIG. 3, symbols S₁ and S₂ are respectively transmitted to a receiver via antennas ANT 1 and ANT 2 on a first subcarrier having frequency f1 in an Orthogonal Frequency Division Multiplexing (OFDM) system, symbols −S*₂ and S*₁ are respectively transmitted via antennas ANT 1 and ANT 2 on a second subcarrier having frequency f2. Therefore a matrix of transmitted symbols from antennas ANT 1 and ANT 2 can be written as:

$$[ \begin{matrix}{T}_{11} & {T}_{12} \\ {T}_{21} & {T}_{22}\end{matrix} ] = [ \begin{matrix}{S}_{1} & - {S}_{2}^{*} \\ {S}_{2} & {S}_{1}^{*}\end{matrix} ] , \qquad ( 1 )$$

The received signal at the receiver on subcarrier having frequency f1 is r₁, and the received signal at the receiver on subcarrier having frequency f2 is r₂. r₁ and r₂ can be written as:

r₁=h₁s₁+h₂s₂+n₁

r₂=−h₁s*₂+h₂s*₁+n₂, (2)

where h₁ and h₂ are channel gains from ANT 1 and ANT 2 respectively. We also assume that the channel from a given antennas does not change between subcarrier having frequency f₁ and subcarrier having frequency f₂. The receiver performs equalization on the received signals and combines the two received signals (r₁ and r₂) to recover the symbols S₁ and S₂. The recovered symbols Ŝ₁ and Ŝ₂ can be written as:

$$\begin{matrix}{\hat{s}}_{1} = {h}_{1}^{*} {r}_{1} + {h}_{2} {r}_{2}^{*} \\ = {h}_{1}^{*} ( {h}_{1} {s}_{1} + {h}_{2} {s}_{2} + {n}_{1} ) + {{h}_{2} ( - {h}_{1} {s}_{2}^{*} + {h}_{2} {s}_{1}^{*} + {n}_{2} )}^{*} \\ = ( {\vert {h}_{1} \vert}^{2} + {\vert {h}_{2} \vert}^{2} ) {s}_{1} + {h}_{1}^{*} {n}_{1} + {h}_{2} {n}_{2}^{*}\end{matrix} \\ \begin{matrix}{\hat{s}}_{2} = {h}_{2}^{*} {r}_{1} + {h}_{1} {r}_{2}^{*} \\ = {h}_{2}^{*} ( {h}_{1} {s}_{1} + {h}_{2} {s}_{2} + {n}_{1} ) + {{h}_{1} ( - {h}_{1} {s}_{2}^{*} + {h}_{2} {s}_{1}^{*} + {n}_{2} )}^{*} \\ = ( {\vert {h}_{1} \vert}^{2} + {\vert {h}_{2} \vert}^{2} ) {s}_{2} + {h}_{2}^{*} {n}_{1} + {h}_{1} {n}_{2}^{*}\end{matrix} \qquad ( 3 )$$

It can be seen that both of the transmitted symbols Ŝ₁ and Ŝ₂ achieve full spatial diversity, that is, the each of the transmitted symbols Ŝ₁ and Ŝ₂ completely removes the interference from the other one.

For the case of four transmission antennas, orthogonal full-diversity block codes are not available. An example of quasi-orthogonal block code also known as ABBA code is given below:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}A & B \\ B & A\end{matrix} ] = [ \begin{matrix}{S}_{1} & - {S}_{2}^{*} & {S}_{3} & - {S}_{4}^{*} \\ {S}_{2} & {S}_{1}^{*} & {S}_{4} & {S}_{3}^{*} \\ {S}_{3} & - {S}_{4}^{*} & {S}_{1} & - {S}_{2}^{*} \\ {S}_{4} & {S}_{3}^{*} & {S}_{2} & {S}_{1}^{*}\end{matrix} ] \qquad ( 4 )$$

where Tᵢⱼ represents the symbol transmitted on the ith antenna and the jth subcarrier or jth time slot (i=1,2,3,4, j=1,2,3,4) for the case of four transmission antennas. A and B are block codes given as below.

$$A = \frac{1}{\sqrt{2}} [ \begin{matrix}{S}_{1} & - {S}_{2}^{*} \\ {S}_{2} & {S}_{1}^{*}\end{matrix} ] \\ B = \frac{1}{\sqrt{2}} [ \begin{matrix}{S}_{3} & - {S}_{4}^{*} \\ {S}_{4} & {S}_{3}^{*}\end{matrix} ] \qquad ( 5 )$$

The problem with quasi-orthogonal block codes is that the loss of orthogonality may result in inter-symbol interference and hence degrades system performance and throughput.

Another example of orthogonal block code for four transmission antennas is SFBC with balanced Frequency Switched Transmit Diversity (FSTD). The code structure can be expressed as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}A & A \\ - B & B\end{matrix} ] = [ \begin{matrix}{S}_{1} & - {S}_{2}^{*} & {S}_{1} & - {S}_{2}^{*} \\ {S}_{2} & {S}_{1}^{*} & {S}_{2} & {S}_{1}^{*} \\ - {S}_{3} & {S}_{4}^{*} & {S}_{3} & - {S}_{4}^{*} \\ - {S}_{4} & - {S}_{3}^{*} & {S}_{4} & {S}_{3}^{*}\end{matrix} ] \qquad ( 6 )$$

Other proposals found in the art for four transmission antennas transmit diversity combines Frequency Switched Transmit Diversity (FSTD) or Time Switched Transmit Diversity (TSTD) with block codes. In case of combined SFBC+FSTD scheme or STBC+TSTD scheme, the matrix of the transmitted symbols from the four transmission antennas are given as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ] \qquad ( 7 )$$

The receiver algorithms for detecting the signal S₁, S₂, S₃, and S₄ can be expressed as:

$$\begin{matrix}{{s}^{⋒}}_{1} = \frac{1}{2} \{ {h}_{1}^{*} ( {r}_{1} + {r}_{3} ) + {h}_{2} ( {r}_{2}^{*} + {r}_{4}^{*} ) \} & ( 8 ) \\ {{s}^{⋒}}_{2} = \frac{1}{2} \{ {h}_{2}^{*} ( {r}_{1} + {r}_{3} ) - {h}_{1} ( {r}_{2}^{*} + {r}_{4}^{*} ) \} & ( 9 ) \\ {{s}^{⋒}}_{3} = \frac{1}{2} \{ {h}_{3}^{*} ( {r}_{3} - {r}_{1} ) + {h}_{4} ( {r}_{4}^{*} - {r}_{2}^{*} ) \} & ( 10 ) \\ {{s}^{⋒}}_{4} = \frac{1}{2} \{ {h}_{4}^{*} ( {r}_{3} - {r}_{1} ) - {h}_{3} ( {r}_{4}^{*} - {r}_{2}^{*} ) \} & ( 11 )\end{matrix}$$

where h₁, h₂, h₃, h₄ are channel gains from ANT 1, ANT 2, ANT 3 and ANT 4, respectively; r₁, r₂, r₃, and r₄ are the received signal for sub-carrier 1, 2, 3, and 4, respectively. r₁, r₂, r₃, and r₄ can be expressed as follow.

r₁=h₁s₁+h₂s₂−h₃s₃−h₄s₄ (12)

r₂=h₂s*₁−h₁s*₂−h₄s*₃+h₃s*₄ (13)

r₃=h₁s*₁+h₁s*₂+h₃s*₃+h₄s*₄ (14)

r₄=h₂s*₁−h₁s*₂+h₄s*₃−h₃s*₄ (15)

The problem with combined SFBC+FSTD scheme and STBC+TSTD schemes is that only a fraction of the total transmission antennas and hence power amplifier (PA) capability is used for transmission in a given frequency or time resource. This is indicated by ‘0’ elements in the SFBC+FSTD and STBC+TSTD matrix given above. When the transmit power on the non-zero elements in the matrix is increased, bursty interference is generated to the neighboring cells degrading system performance.

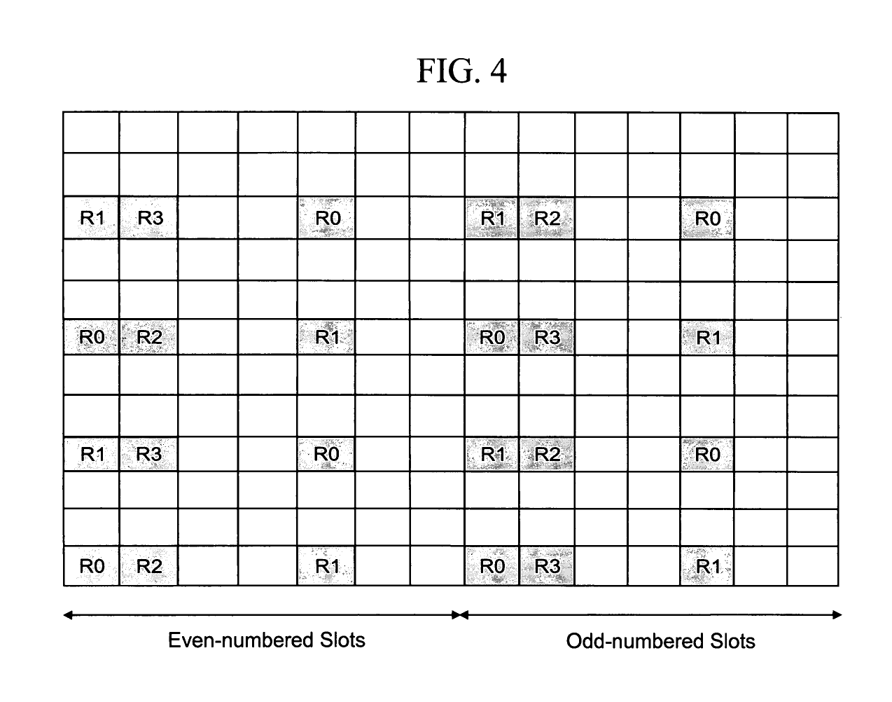

The downlink reference signals mapping for four transmission antennas in the 3GPP LTE (3^{rd} Generation Partnership Project Long Term Evolution) system is shown in FIG. 4. The notation Rₚ is used to denote a resource element used for reference signal transmission on antenna port p. It can be noted that density on antenna ports 2 and 3 is half the density on antenna ports 0 and 1. This leads to weaker channel estimates on antenna ports 2 and 3 relative to channel estimates on antenna ports 0 and 1.

In case of combined SFBC+FSTD scheme or STBC+TSTD scheme for four transmission antennas, the symbols S₁ and S₂ are transmitted from antenna ports 0 and 1, while symbols S₃ and S₄ are transmitted from antenna ports 2 and 3. The received symbol estimates are given as:

$$\begin{matrix}{\hat{s}}_{1} = {h}_{1}^{*} {r}_{1} + {h}_{2} {r}_{2}^{*} \\ = ( {\vert {h}_{1} \vert}^{2} + {\vert {h}_{2} \vert}^{2} ) {s}_{1} + {h}_{1}^{*} {n}_{1} + {h}_{2} {n}_{2}^{*}\end{matrix} \\ \begin{matrix}{\hat{s}}_{2} = {h}_{2}^{*} {r}_{1} + {h}_{1} {r}_{2}^{*} \\ = ( {\vert {h}_{1} \vert}^{2} + {\vert {h}_{2} \vert}^{2} ) {s}_{2} + {h}_{2}^{*} {n}_{1} + {h}_{1} {n}_{2}^{*}\end{matrix} \\ \begin{matrix}{\hat{s}}_{3} = {h}_{3}^{*} {r}_{3} + {h}_{4} {r}_{4}^{*} \\ = ( {\vert {h}_{3} \vert}^{2} + {\vert {h}_{4} \vert}^{2} ) {s}_{3} + {h}_{3}^{*} {n}_{3} + {h}_{4} {n}_{4}^{*}\end{matrix} \\ \begin{matrix}{\hat{s}}_{4} = {h}_{4}^{*} {r}_{3} + {h}_{3} {r}_{4}^{*} \\ = ( {\vert {h}_{3} \vert}^{2} + {\vert {h}_{4} \vert}^{2} ) {s}_{4} + {h}_{4}^{*} {n}_{3} + {h}_{3} {n}_{4}^{*}\end{matrix} \qquad ( 16 )$$

where h₁, h₂, h₃, h₄ denote channel gains from antenna port 0, 1, 2 and 3 respectively; r₁, r₂, r₃, and r₄ are the received signal for sub-carriers 1, 2, 3, and 4 in the case of SFBC+FSTD respectively, or for time slots 1, 2, 3, and 4 in the case of STBC+TSTD, respectively. It can be seen that symbols S₁ and S₂ transmitted from antennas ports 0 and 1 benefit from more reliable channel estimates than symbols S₃ and S₄ transmitted from antenna ports 2 and 3. This is because the reference signal density is twice as high on antenna ports 0 and 1 relative to antenna ports 2 and 3, as shown in FIG. 4. This results in degraded performance on symbols S₃ and S₄ and thus impacting the system throughput.

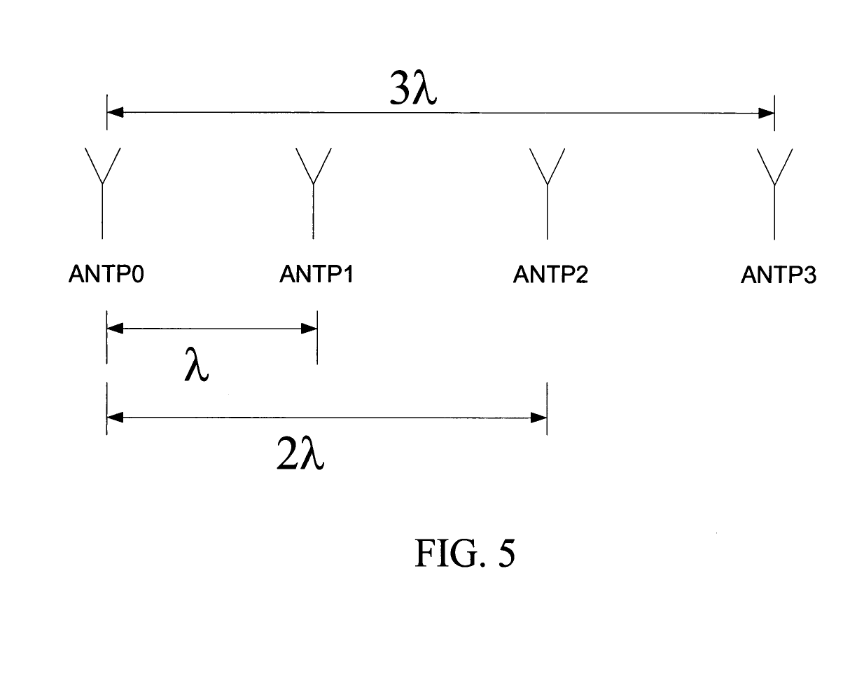

The antenna correlation depends upon, among other factors, angular spread and antennas spacing. In general, for a given angle spread, the larger the antenna spacing the smaller the correlation among the antennas. An example of antenna spacing for the case of four transmission antennas is shown in FIG. 5. The four transmission antennas are sequentially aligned in a row, with a distance of λ between neighboring antennas. It can be seen that the correlation between antenna ports ANTP0 and ANTP1 is larger than the correlation between antenna ports ANTP0 and ANTP2. Similarly, the correlation between antenna ports ANTP2 and ANTP3 is larger than the correlation between antenna ports ANTP1 and ANTP3.

Assume that symbols from the combined SFBC+FSTD scheme or STBC+TSTD scheme are transmitted via the antennas shown in FIG. 5, the symbols can be expressed as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ] \qquad ( 17 )$$

where Tᵢⱼ represents the symbol transmitted on the ith antenna and the jth subcarrier or jth time slot, and i=1,2,3,4, j=1,2,3,4 for the case of four transmission antennas. Accordingly, symbols S₁ and S₂ are transmitted via ANTP0 and ANTP1, while symbols S₃ and S₄ are transmitted via ANPT2 and ANTP3. This results in degraded transmit diversity performance for symbols S₁ and S₂ because the correlation between ANTP0 and ANTP1 is higher compared to the correlation between ANTP0 and ANTP2, or the correlation between ANTP1 and ANTP3. Similarly, symbols S₃ and S₄ may also experience a degraded transmit diversity performance because ANTP2 and ANTP3 have higher correlation compared to the correlation between ANTP0 and ANTP2, or the correlation between ANTP1 and ANTP3.

Another approach of transmit diversity scheme for four transmission antennas is called SFBC-Phase Switched Diversity (SFBC-PSD), where the transmit space-frequency code structure is given by:

$$[ \begin{matrix}{S}_{1} & - {S}_{2}^{*} \\ {S}_{2} & {S}_{1}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )}\end{matrix} ] \qquad ( 18 )$$

where g=[k/2] is the group index of two subcarriers, and k is the subcarrier index. Functions b₁(g) and b₂(g) are two pseudo-random phase shift vectors that are functions of the subcarrier group index g, and they are known at Node-B (i.e., the base station) and all User Equipments (UEs).

Another approach of transmit diversity scheme for four transmission antennas is called SFBC-Cyclic Delay Diversity (SFBC-CDD), where the transmit space-frequency code structure is given by:

$$[ \begin{matrix}{S}_{1} & - {S}_{2}^{*} \\ {S}_{2} & {S}_{1}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}}\end{matrix} ] \qquad ( 19 )$$

where k is the subcarrier index, and b₁ and b₂ are two fixed phase angles. Note that in this case, a simple orthogonal detection algorithm does not exist, and either Maximum Likelihood (ML) receivers, or Minimum Mean Square Error (MMSE) receivers, or other advanced receivers are needed to capture diversity.

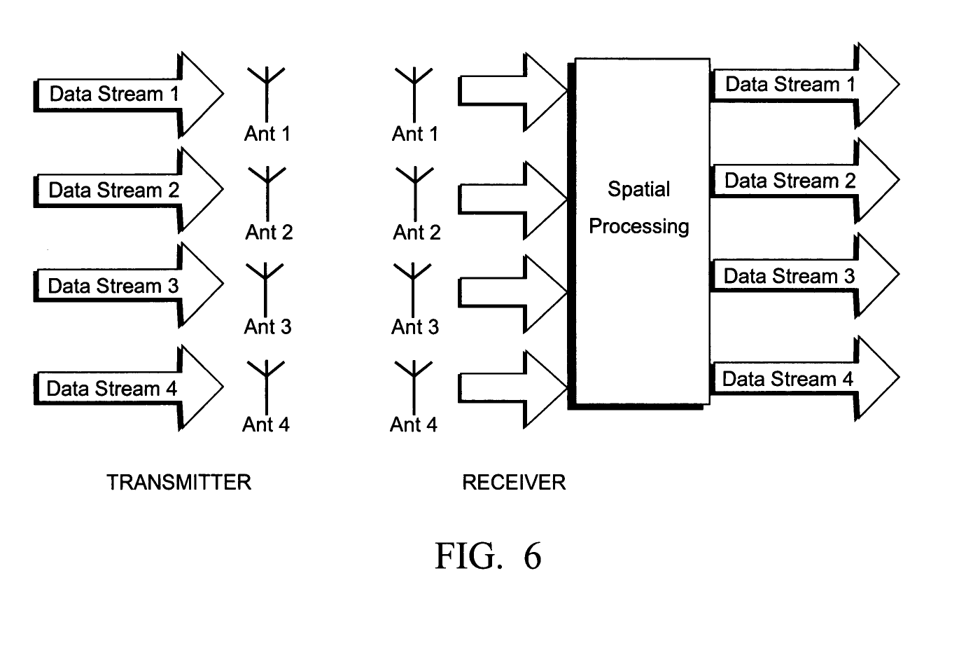

Multiple Input Multiple Output (MIMO) schemes use multiple transmission antennas and multiple receive antennas to improve the capacity and reliability of a wireless communication channel. A MIMO system promises linear increase in capacity with K where K is the minimum of number of transmit (M) and receive antennas (N), i.e. K=min(M,N). A simplified example of a 4×4 MIMO system is shown in FIG. 6. In this example, four different data streams are transmitted separately from the four transmission antennas. The transmitted signals are received at the four receive antennas. Some form of spatial signal processing is performed on the received signals in order to recover the four data streams. An example of spatial signal processing is vertical Bell Laboratories Layered Space-Time (V-BLAST) which uses the successive interference cancellation principle to recover the transmitted data streams. Other variants of MIMO schemes include schemes that perform some kind of space-time coding across the transmission antennas (e.g., diagonal Bell Laboratories Layered Space-Time (D-BLAST)) and also beamforming schemes such as Spatial Division multiple Access (SDMA).

The MIMO channel estimation consists of estimating the channel gain and phase information for links from each of the transmission antennas to each of the receive antennas. Therefore, the channel for M×N MIMO system consists of an N×M matrix:

$$H = [ \begin{matrix}{h}_{11} & {h}_{12} & ⋯ & {h}_{1 M} \\ {h}_{21} & {h}_{22} & ⋯ & {h}_{2 M} \\ ⋮ & ⋮ & ⋯ & ⋮ \\ {h}_{N 1} & {h}_{M 2} & ⋯ & {h}_{NM}\end{matrix} ] . \qquad ( 20 )$$

where hᵢⱼ represents the channel gain from transmission antenna j to receive antenna i. In order to enable the estimations of the elements of the MIMO channel matrix, separate pilots are transmitted from each of the transmission antennas.

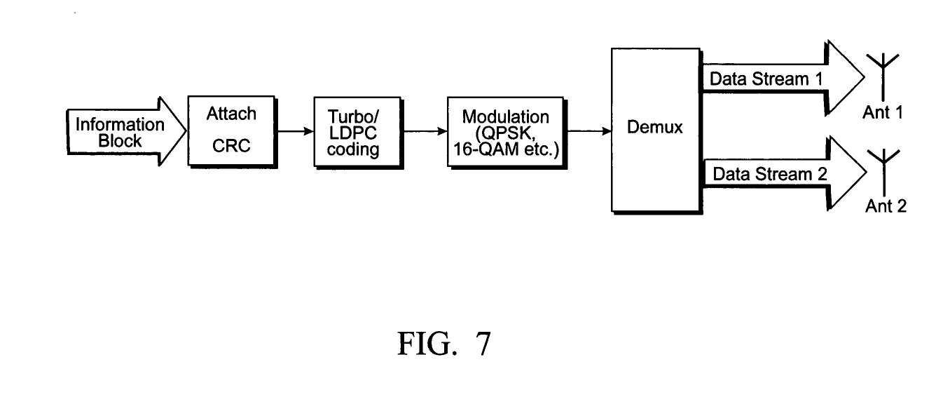

An example of single-code word MIMO scheme is given in FIG. 7. In case of single-code word MIMO transmission, a cyclic redundancy check (CRC) is added to a single information block and then coding, for example, using turbo codes and low-density parity check (LDPC) code, and modulation, for example, by quadrature phase-shift keying (QPSK) modulation scheme, are performed. The coded and modulated symbols are then demultiplexed for transmission over multiple antennas.

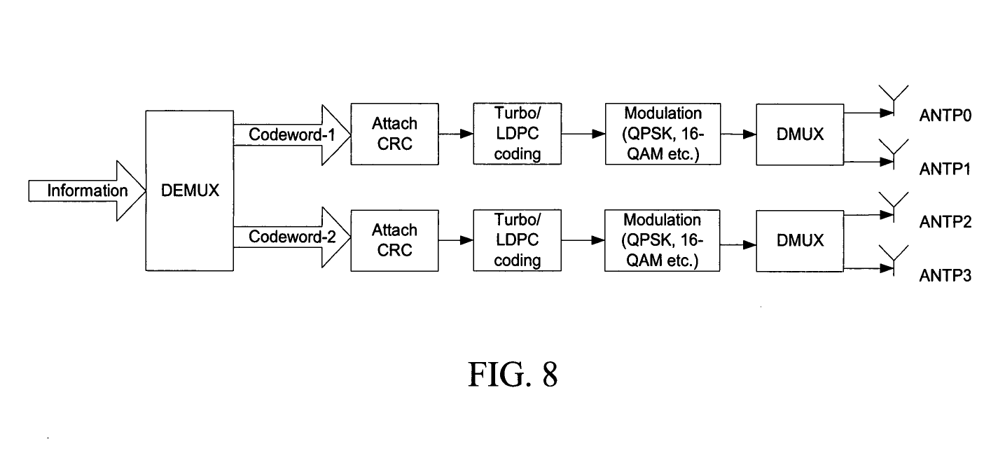

In case of multiple codeword MIMO transmission, shown in FIG. 8, the information block is de-multiplexed into smaller information blocks. Individual CRCs are attached to these smaller information blocks and then separate coding and modulation is performed on these smaller blocks. After modulation, these smaller blocks are respectively demultiplexed into even smaller blocks and then transmitted through corresponding antennas. It should be noted that in case of multi-code word MIMO transmissions, different modulation and coding can be used on each of the individual streams, and thus resulting in a so-called Per Antenna Rate Control (PARC) scheme. Also, multi-code word transmission allows for more efficient post-decoding interference cancellation because a CRC check can be performed on each of the code words before the code word is cancelled from the overall signal. In this way, only correctly received code words are cancelled, and thus avoiding any interference propagation in the cancellation process. In the 3GPP LTE for rank 4 or 4 layers transmission, codeword-1 (CW1) is transmitted from antenna ports ANTP0 and ANTP1, while CW2 is transmitted from antenna ports ANTP2 and ANTP3. This results in weaker channel estimates and degraded performance for CW2 due to lower density of ANTP2 and ANTP3 reference signal density.

Similarly, codeword-1 (CW1) mapped to ANTP0 and ANTP1 experience less diversity because of higher correlation between ANTP0 and ANTP1. Similarly, codeword-2 (CW2) mapped to ANTP2 and ANTP3 experience less diversity because of higher correlation between ANTP2 and ANTP3.

In a first embodiment according to the principles of the present invention, we describe an open-loop transmit diversity scheme where symbols S₁ and S₂ are transmitted via antennas ports ANTP0 and ANTP2 as shown in FIG. 5, while symbols S₃ and S₄ are transmitted over antenna ports ANTP1 and ANTP3, as shown in FIG. 5. The transmit matrix is given as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ] \qquad ( 21 )$$

where Tᵢⱼ represents symbol transmitted on the ith antenna port and the jth subcarrier or jth time slot, and i=1,2,3,4, j=1,2,3,4 for the case of four transmission antennas.

The received symbol estimates are given as:

$$\begin{matrix}{\hat{s}}_{1} = {h}_{1}^{*} {r}_{1} + {h}_{3} {r}_{2}^{*} \\ = ( {\vert {h}_{1} \vert}^{2} + {\vert {h}_{3} \vert}^{2} ) {s}_{1} + {h}_{1}^{*} {n}_{1} + {h}_{3} {n}_{2}^{*}\end{matrix} \\ \begin{matrix}{\hat{s}}_{2} = {h}_{3}^{*} {r}_{1} + {h}_{1} {r}_{2}^{*} \\ = ( {\vert {h}_{1} \vert}^{2} + {\vert {h}_{3} \vert}^{2} ) {s}_{2} + {h}_{3}^{*} {n}_{1} + {h}_{1} {n}_{2}^{*}\end{matrix} \\ \begin{matrix}{\hat{s}}_{3} = {h}_{2}^{*} {r}_{3} + {h}_{4} {r}_{4}^{*} \\ = ( {\vert {h}_{2} \vert}^{2} + {\vert {h}_{4} \vert}^{2} ) {s}_{3} + {h}_{2}^{*} {n}_{3} + {h}_{4} {n}_{4}^{*}\end{matrix} \\ \begin{matrix}{\hat{s}}_{4} = {h}_{4}^{*} {r}_{3} + {h}_{2} {r}_{4}^{*} \\ = ( {\vert {h}_{2} \vert}^{2} + {\vert {h}_{4} \vert}^{2} ) {s}_{4} + {h}_{4}^{*} {n}_{3} + {h}_{2} {n}_{4}^{*}\end{matrix} \qquad ( 22 )$$

where h₁, h₂, h₃, h₄ denote channel gains from antenna ports 0, 1, 2 and 3 respectively; n₁, n₂, n₃, and n₄ represents noise for sub-carriers 1, 2, 3, and 4 in the case of SFBC respectively, or for time slots 1, 2, 3, and 4 in the case of STBC, respectively. It can be seen that symbols S₁ and S₂ transmitted from antennas ports 0 and 2 experience a good channel estimate h₁ and a weak channel estimate h₃. Similarly, symbols S₃ and S₄ transmitted from antenna ports 1 and 3 experience a good channel estimate h₂ and a weak channel estimate h₄. This way the effect of weaker channel estimates is distributed across all the four symbols, S₁, S₂, S₃, and S₄.

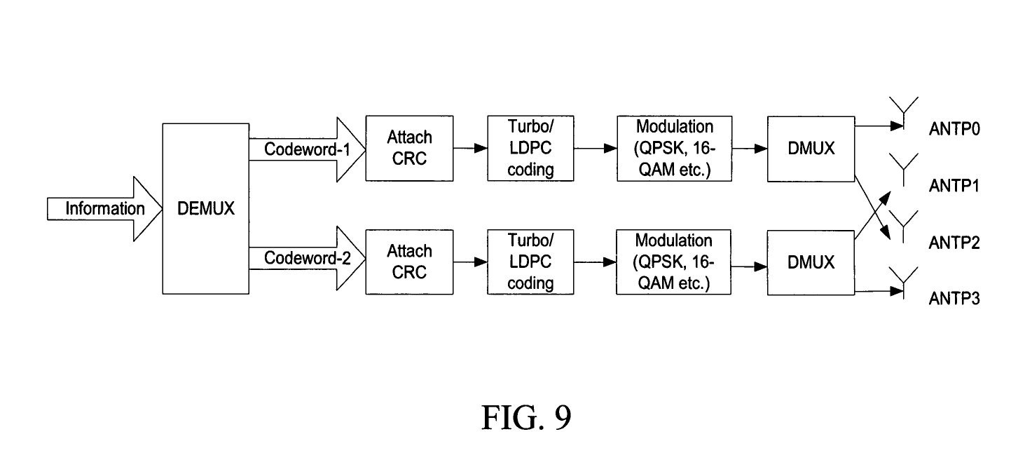

The Multi-code word MIMO scheme according to the principles of the current invention is shown in FIG. 9. The codeword 1 (CW1) is mapped to antennas ports 0 and 2 while ICW2 is mapped to antenna ports 1 and 3. This way the effect of weaker channel estimates on antenna ports 2 and 3 is distributed across the 2 codeword transmission.

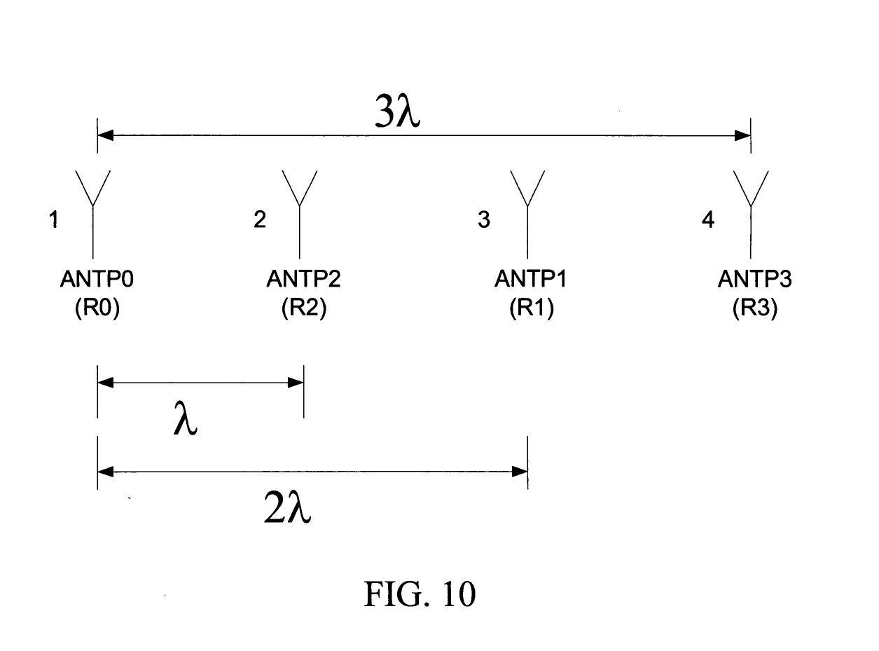

In a second embodiment according to the principles of the present invention, reference symbols for the four transmission antennas are mapped as shown in FIG. 10. Reference signals R0, R1, R2 and R3 are mapped to physical antennas 1, 3, 2 and 4 respectively. In this case, each antenna port is defined by the reference signal transmitted on the port. That is, antenna port ANTP0 is defined by reference signal R0, antenna port ANTP1 is defined by reference signal R1, antenna port ANTP2 is defined by reference signal R2, and antenna port ANTP4 is defined by reference signal R4. Because reference signals R0, R1, R2 and R3 are mapped to physical antennas 1, 3, 2 and 4 respectively, antenna port ANTP0 corresponds to physical antenna 1, antenna port ANTP2 corresponds to physical antenna 2, antenna port ANTP 1 corresponds to physical antenna 3, antenna port ANTP3 corresponds to physical antenna 4. The large spacing between physical antenna 1 and physical antenna 3 assures that antenna ports ANTP0 and ANTP1 have larger spacing than the case without the antenna port mapping, and hence smaller correlation. It should be noted that smaller correlation among antenna ports means higher achievable diversity. Similarly, ANTP2 and ANTP3 have larger spacing and hence smaller correlation.

Now we assume the symbols in the combined SFBC+FSTD scheme or STBC+TSTD scheme are transmitted via the antenna ports shown in FIG. 10. In case of combined SFBC+FSTD scheme or STBC+TSTD scheme, the transmitted symbols from the antenna ports are given as:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ] \qquad ( 23 )$$

where Tᵢⱼ represents symbol transmitted on the (i−1)th antenna port and the jth subcarrier or jth time slot, and i=1,2,3,4, j=1,2,3,4 for the case of four transmission antennas. That is, symbols T₁₁, T₁₂, T₁₃, and T₁₄ are transmitted via antenna port ANTP0 which corresponds to the physical antenna 1, symbols T₂₁, T₂₂, T₂₃, and T₂₄ are transmitted via antenna port ANTP1 which corresponds to the physical antenna 3, symbols T₃₁, T₃₂, T₃₃, and T₃₄ are transmitted via antenna port ANTP2 which corresponds to the physical antenna 2, and symbols T₄₁, T₄₂, T₄₃, and T₄₄ are transmitted via antenna port ANTP3 which corresponds to the physical antenna 4.

The received symbol estimates are given as:

$${\hat{s}}_{1} = ( {\vert {h}_{1} \vert}^{2} + {\vert {h}_{2} \vert}^{2} ) {s}_{1} + {h}_{1}^{*} {n}_{1} + {h}_{2} {n}_{2}^{*} \\ {\hat{s}}_{2} = ( {\vert {h}_{1} \vert}^{2} + {\vert {h}_{2} \vert}^{2} ) {s}_{2} + {h}_{2}^{*} {n}_{1} + {h}_{1} {n}_{2}^{*} \\ {\hat{s}}_{3} = ( {\vert {h}_{2} \vert}^{2} + {\vert {h}_{4} \vert}^{2} ) {s}_{3} + {h}_{2}^{*} {n}_{3} + {h}_{4} {n}_{4}^{*} \\ {\hat{s}}_{4} = ( {\vert {h}_{2} \vert}^{2} + {\vert {h}_{4} \vert}^{2} ) {s}_{4} + {h}_{4}^{*} {n}_{3} + {h}_{2} {n}_{4}^{*} \qquad ( 24 )$$

where h₁, h₂, h₃, h₄ denote channel gains from antenna ports 0, 1, 2 and 3 respectively; n₁, n₂, n₃, and n₄ represents noise for sub-carriers 1, 2, 3, and 4 in the case of SFBC respectively, or for time slots 1, 2, 3, and 4 in the case of STBC, respectively. It can be seen that symbols S₁ and S₂ experience higher diversity due to larger spacing between antenna port 0 and antenna port 1. Similarly, symbols S₃ and S₄ experience higher diversity due to larger spacing between antenna port 2 and antenna port 3 according to antenna ports to physical antennas mapping shown in FIG. 10.

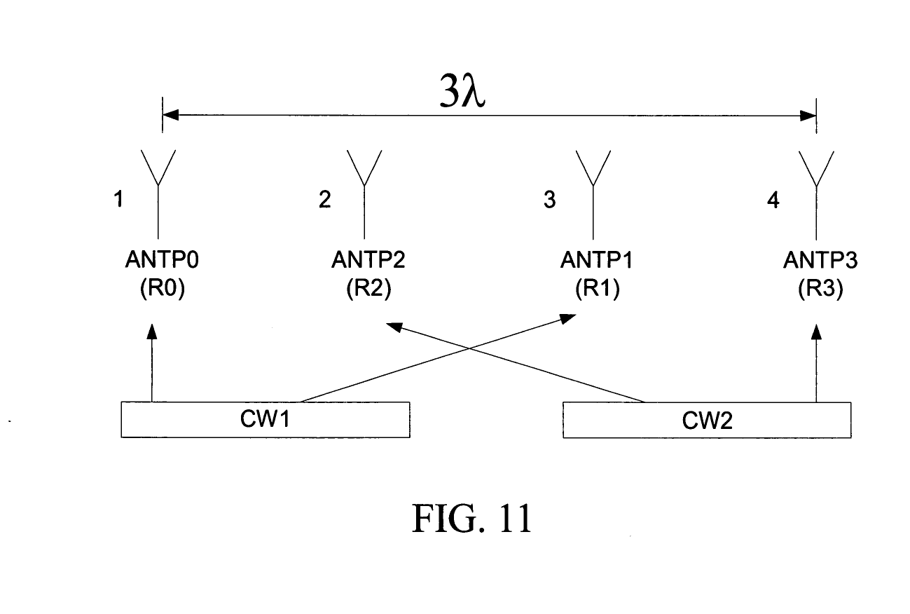

In a third embodiment according to the principles of the present invention shown in FIG. 11, CW1 is mapped to ANTP0 and ANTP1 while CW2 is mapped to ANTP2 and ANTP3 with antenna ports to physical antennas mapping as shown in FIG. 10. It can be seen that with this mapping of CW to antenna ports and the mapping of antenna ports to physical antenna mapping of FIG. 10, both codewords experience larger diversity compared to the case where ANTP0, ANTP1, ANTP2 and ANTP3 are mapped to physical antennas 1, 2, 3 and 4 respectively.

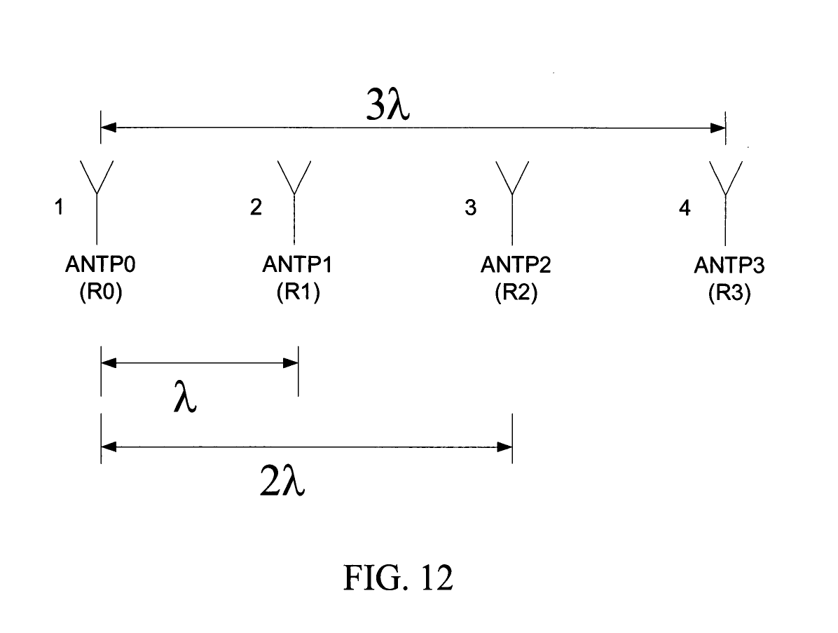

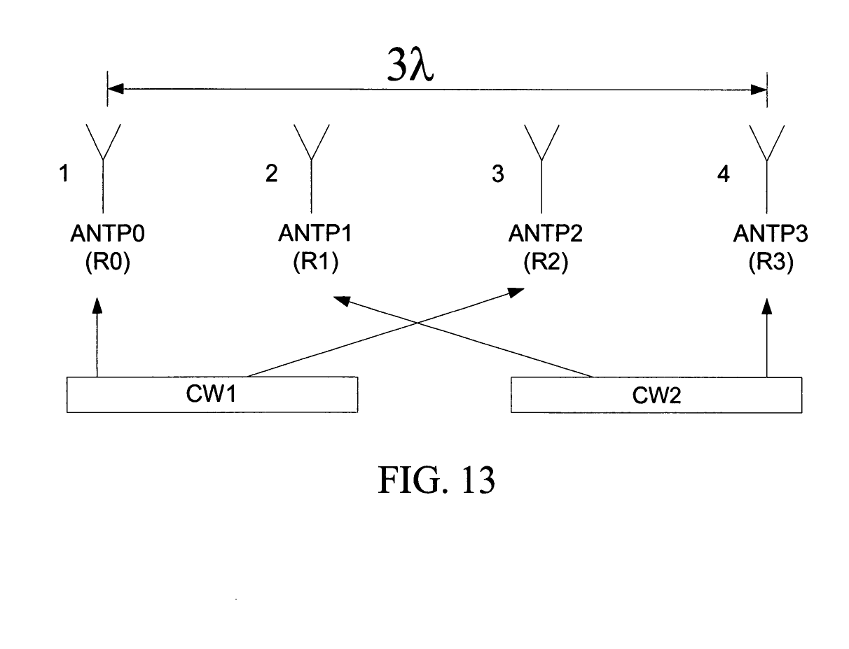

In a fourth embodiment according to the principles of the present invention, reference symbols for the four transmission antennas are mapped as shown in FIG. 12. The reference signal R0, R1, R2 and R3 are mapped to physical antennas 1, 2, 3 and 4 respectively. For the open-loop transmit diversity scheme, symbols S₁ and S₂ are transmitted over antennas ports ANTP0 and ANTP2 while symbols S₃ and S₄ are transmitted over antenna ports ANTP1 and ANTP3 as given by the transmit matrix below:

$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ] \qquad ( 25 )$$

where Tᵢⱼ represents symbol transmitted on the (i−1)th antenna port and the jth subcarrier or jth time slot, and i=1,2,3,4, j=1,2,3,4 for the case of four transmission antennas. The received symbol estimates are given as:

$$\begin{matrix}{\hat{s}}_{1} = {h}_{1}^{*} {r}_{1} + {h}_{3} {r}_{2}^{*} \\ = ( {\vert {h}_{1} \vert}^{2} + {\vert {h}_{3} \vert}^{2} ) {s}_{1} + {h}_{1}^{*} {n}_{1} + {h}_{3} {n}_{2}^{*}\end{matrix} \\ \begin{matrix}{\hat{s}}_{2} = {h}_{3}^{*} {r}_{1} + {h}_{1} {r}_{2}^{*} \\ = ( {\vert {h}_{1} \vert}^{2} + {\vert {h}_{3} \vert}^{2} ) {s}_{2} + {h}_{3}^{*} {n}_{1} + {h}_{1} {n}_{2}^{*}\end{matrix} \\ \begin{matrix}{\hat{s}}_{3} = {h}_{2}^{*} {r}_{3} + {h}_{4} {r}_{4}^{*} \\ = ( {\vert {h}_{2} \vert}^{2} + {\vert {h}_{4} \vert}^{2} ) {s}_{3} + {h}_{2}^{*} {n}_{3} + {h}_{4} {n}_{4}^{*}\end{matrix} \\ \begin{matrix}{\hat{s}}_{4} = {h}_{4}^{*} {r}_{3} + {h}_{2} {r}_{4}^{*} \\ = ( {\vert {h}_{2} \vert}^{2} + {\vert {h}_{4} \vert}^{2} ) {s}_{4} + {h}_{4}^{*} {n}_{3} + {h}_{2} {n}_{4}^{*}\end{matrix} \qquad ( 26 )$$

where h₁, h₂, h₃, h₄ denote channel gains from antenna ports 0, 1, 2 and 3 respectively; n₁, n₂, n₃, and n₄ represents noise for sub-carriers 1, 2, 3, and 4 in the case of SFBC respectively, or for time slots 1, 2, 3, and 4 in the case of STBC, respectively. It can be seen that with the mapping of antenna ports to physical antennas shown in FIG. 12 and symbol transmission matrix shown above, both the diversity within a symbol is maximized and also effect of channel estimates is distributed-evenly between the pair of symbols S₁ and S₂ and the pair of symbols S₃ and S₄.

In a fifth embodiment according to the principles of the present invention, as shown in FIG. 13, CW1 is mapped to ANTP0 and ANTP2 while CW2 is mapped to ANTP1 and ANTP3 using antenna ports to physical antenna mapping as shown in FIG. 12. In this case, both CW1 and CW2 experience larger diversity due to the spacing between antenna ports ANTP0 and ANTP2 and antenna ports ANTP1 and ANTP3. Also, the effect of weaker channel estimates from antenna ports ANTP2 and ANTP3 is uniformly distributed on the two codewords.

In a sixth embodiment according to the principles of the present invention, we derive the six permuted version of SFBC-PSD matrices:

$${P}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )}\end{matrix} ] , \\ {P}_{B} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] , \\ {P}_{C} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{D} = [ \begin{matrix}{S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{1} ( i ) & - {S}_{2}^{*} ( i ) \\ {S}_{2} ( i ) & {S}_{1}^{*} ( i )\end{matrix} ] , \\ {P}_{E} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{F} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] , \qquad ( 27 )$$

where i=1, . . . , N, and N is the number of the symbols. While the transmitter maps the modulated symbols to the physical time-frequency OFDM resource, it select a subset of K (1≦K≦6) permuted matrices from the six permuted SFBC-PSD matrices. Afterward, the transmitter divides up the modulated signal into K parts, each of the K parts contains 2M symbols, where M is an positive integer and M≧1. Each of the K parts uses a different permuted matrix from the subset of K matrices. One example is to let K=3, and let the three permuted matrices be P_{A},P_{B},P_{C}. And we also assume there are 30 modulated symbols S₁, S₂, . . . , S₃₀. The 30 modulated symbols are divided into 3 parts: the first part contains symbols S₁, S₂, S₇, S₈, S₁₃, S₁₄, S₁₉, S₂₀, S₂₅, S₂₆; the second part contains symbols S₃, S₄, S₉, S₁₀, S₁₅, S₁₆, S₂₁, S₂₂, S₂₇, S₂₈; and the third part contains symbols S₅, S₆, S₁₁, S₁₂, S₁₇, S₁₈, S₂₃, S₂₄, S₂₉, S₂₀. In this example, these three matrices P_{A},P_{B},P_{C} will be applied along the frequency dimension, in a pattern that repeats every 6 sub-carriers. That is, P_{A} is assigned to each pair of modulated symbols in the first part of modulated symbols, P_{B} is assigned to each pair of modulated symbols in the second part of modulated symbols, and P_{C} is assigned to each pair of modulated symbols in the third part of modulated symbols.

In a seventh embodiment according to the principles of the present invention, the Node-B, i.e., the base station, selects a subset of K (1≦K≦6) permuted SFBC-PSD matrices for the purpose of Hybrid Automatic Repeat-reQuest (HARQ) transmission. Furthermore, the Node-B applies different SFBC-PSD matrices within this subset of K permuted SFBC-PSD matrices on different retransmissions of the packet. Noteworthy, this approach of applying permuted SFBC-PSD matrices on retransmissions apply to both Chase Combining and incremental redundancy.

In an eighth embodiment according to the principles of the present invention, we derive the six permuted version of SFBC-CDD matrices:

$${C}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{B} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{C} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{D} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{1} ( i ) & - {S}_{2}^{*} ( i ) \\ {S}_{2} ( i ) & {S}_{1}^{*} ( i )\end{matrix} ] , \\ {C}_{E} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{C} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ] \qquad ( 21 )$$

where k is the subcarrier index, and θ₁ and θ₂ are two fixed phase angles, i=1, . . . N, and N is the number of the symbols. While the transmitter maps the modulated symbols to the physical time-frequency OFDM resource, it select a subset of K (1≦K≦6) permuted matrices from the six permuted SFBC-CDD matrices. Afterward, the transmitter divides up the modulated signal into K parts, each uses a different permuted matrix from the subset of K matrices. One example is to let K=3, and let the three permuted matrices be C_{A},C_{B},C_{C}. In this example, these three matrices will be applied along the frequency dimension, in a pattern that repeats every 6 sub-carriers.

In a ninth embodiment according to the principles of the present invention, the Node-B select a subset of K (1≦K≦6) permuted SFBC-CDD matrices for the purpose of HARQ. Furthermore, the Node-B applies different SFBC-CDD matrices within this subset on different retransmissions of the packet. Noteworthy, this approach of applying permuted SFBC-CDD matrices on retransmissions apply to both Chase Combining and incremental redundancy.

Note that the present invention does not limit the number of the antennas. That is, a communication system may have more than four transmission antennas. For example, two code words, CW1 and CW2 are transmitted via ten transmission antennas. Then CW1 can be map to even numbered antenna ports, i.e., ANTP0, ANTP2, ANTP4, ANTP6 and ANTP8, while CW2 can be map to odd numbered antenna ports, i.e., ANTP1, ANTP3, ANTP5, ANTP7 and ANTP9. For the case of SFBC-FSTD, we can create five pairs of symbols S₁ and S₂, S₃ and S₄, S₅ and S₆, S₇ and S₈, S₉ and S₁₀. We can then map each pair to antennas to maximize transmit diversity gain. For example, the first pair S₁ and S₂ can be mapped to antenna ports 0 and 5, the second pair S₃ and S₄ can be mapped to antenna ports 1 and 6, and the last pair S₉ and S₁₀ to ports 4 and 9.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method for transmission, the method comprising the steps of:
demultiplexing information to be transmitted into a plurality of stream blocks;
inserting a respective cyclic redundancy check to each of the stream blocks;
encoding each of the stream blocks according to a corresponding coding scheme;
modulating each of the stream blocks according to a corresponding modulation scheme;
demultiplexing the stream blocks to generate a plurality of sets of symbols, with each stream block being demultiplexed into a set of symbols; and
transmitting the plurality of symbols via a plurality of antenna ports, with each antenna port connecting to a corresponding physical antenna, each set of symbols being transmitted via a subset of the plurality of antenna ports, and the antenna ports having weaker channel estimates being equally distributed among the plurality of subsets of antenna ports.

2. The method of claim 1, comprised of transmitting four symbols via four antenna ports according to a transmission matrix, with a first symbol and a second symbol being generated from a first stream block, a third symbol and a fourth symbol being generated from a second stream block, the first and second antenna ports having higher channel estimates than the third and the fourth antenna ports, the first symbol being transmitted via the first antenna port, the second symbol being transmitted via the third antenna port, the third symbol being transmitted via the second antenna port, and the fourth symbol being transmitted via the fourth antenna port.

3. The method of claim 2, comprised of the first antenna port, the second antenna port, the third antenna port, and the fourth antenna port respectively connecting to a first physical antenna, a second physical antenna, a third physical antenna, and a fourth physical antenna, and the first through fourth physical antenna being aligned sequentially with equal spacing between two immediately adjacent physical antennas.

4. A method for transmission, the method comprising the steps of:
generating a plurality of reference signals for a plurality of physical antennas, with each reference signal corresponding to a physical antenna;
transmitting the plurality of reference signals via a plurality of antenna ports connected to the plurality of physical antennas in accordance with a selected antenna port mapping scheme;
modulating data to be transmitted into a plurality of modulated symbols;
encoding each pair of modulated symbols from among said plurality of symbols in accordance with a transmission diversity scheme to result in a plurality of 2 by 2 matrices, with each 2 by 2 matrix corresponding to each pair of modulated symbols;
generating a transmission matrix comprising the plurality of 2 by 2 matrices, with the transmission matrix being established by:
$$[ \begin{matrix}{T}_{11} & {T}_{12} & {T}_{13} & {T}_{14} & ⋯ & {T}_{1 , 2 M - 1} & {T}_{1 , 2 M} \\ {T}_{21} & {T}_{22} & {T}_{23} & {T}_{24} & ⋯ & {T}_{2 , 2 M - 1} & {T}_{2 , 2 M} \\ {T}_{31} & {T}_{32} & {T}_{33} & {T}_{34} & ⋯ & {T}_{3 , 2 M - 1} & {T}_{3 , 2 M} \\ {T}_{41} & {T}_{42} & {T}_{43} & {T}_{44} & ⋯ & {T}_{4 , 2 M - 1} & {T}_{4 , 2 M} \\ ⋮ & ⋮ & ⋮ & ⋮ & ⋰ & ⋮ & ⋮ \\ {T}_{2 M - 1 , 1} & {T}_{2 M - 1 , 2} & {T}_{2 M - 1 , 3} & {T}_{2 M - 1 , 4} & ⋯ & {T}_{2 M - 1 , 2 M - 1} & {T}_{2 M - 1 , 2 M - 1} \\ {T}_{2 M , 1} & {T}_{2 M , 2} & {T}_{2 M , 3} & {T}_{2 M , 4} & ⋯ & {T}_{2 M , 2 M - 1} & {T}_{2 M , 2 M}\end{matrix} ] = [ \begin{matrix}{S}_{1} & - {S}_{2}^{*} & 0 & 0 & ⋯ & 0 & 0 \\ {S}_{2} & {S}_{1}^{*} & 0 & 0 & ⋯ & 0 & 0 \\ 0 & 0 & {S}_{3} & - {S}_{4}^{*} & ⋯ & 0 & 0 \\ 0 & 0 & {S}_{4} & {S}_{3}^{*} & ⋯ & 0 & 0 \\ ⋮ & ⋮ & ⋮ & ⋮ & ⋰ & ⋮ & ⋮ \\ 0 & 0 & 0 & 0 & ⋯ & {S}_{2 M - 1} & - {S}_{2 M}^{*} \\ 0 & 0 & 0 & 0 & ⋯ & {S}_{2 M} & {S}_{2 M - 1}^{*}\end{matrix} ]$$
where M is the total number of the 2 by 2 matrices, S₁ through S_{2M-1} are the plurality of modulated symbols, Tᵢⱼ represents the symbol transmitted on the ith antenna port and the jth subcarrier or jth time slot; and
transmitting the plurality of modulated symbols in the transmission matrix via the plurality of antenna ports in accordance with the transmission matrix.

5. The method of claim 4, with the selected antenna port mapping scheme being established such that the (2×i)-th antenna port is connected to the (2×i+1)-th physical antenna, and the (2×i+1)-th antenna port is connected to the (2×i)-th physical antenna, where i=1, 2, . . . M−1, and the total number of antenna ports is 2×M, and the total number of physical antennas is 2×M.

6. The method of claim 4, comprised of, when there are four physical antennas and four antenna ports, modulating data to be transmitted into four modulated symbols, with,
the selected antenna port mapping scheme being established such that a first antenna port is mapped to a first physical antenna, a second antenna port is mapped to a third physical antenna, a third antenna port is mapped to a second physical antenna, and a fourth antenna port is mapped to a fourth physical antenna, with the four physical antennas being aligned sequentially with equal spacing between two immediately adjacent physical antennas, and
the transmission matrix being established as:
$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ]$$
where Tᵢⱼ represents the symbol transmitted on the ith antenna port and the jth subcarrier or jth time slot, S₁, S₂, S₃, and S₄ represent the first through the fourth symbols respectively.

7. The method of claim 4, comprised of, when there are four physical antennas and four antenna ports, modulating data to be transmitted into four modulated symbols, and exchanging a selected pair of rows in the transmission matrix to generate a new transmission matrix, with,
the selected antenna port mapping scheme being established such that a first antenna port is mapped to a first physical antenna, a second antenna port is mapped to a second physical antenna, a third antenna port is mapped to a third physical antenna, and a fourth antenna port is mapped to a fourth physical antenna, with the four physical antennas being aligned sequentially with equal spacing between two immediately adjacent physical antennas, and
the new transmission matrix being established as:
$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ]$$
where Tᵢⱼ represents the symbol transmitted on the ith antenna port and the jth subcarrier or jth time slot, S₁, S₂, S₃, and S₄ represent the first through the fourth symbols respectively.

8. A method for transmission, the method comprising the steps of:
generating a plurality of reference signals for a plurality of physical antennas, with each reference signal corresponding to a physical antenna;
transmitting the plurality of reference signals via a plurality of antenna ports connected to the plurality of physical antennas in accordance with a selected antenna port mapping scheme;
demultiplexing information to be transmitted into a plurality of stream blocks;
inserting a respective cyclic redundancy check to each of the stream blocks;
encoding each of the stream blocks according to a corresponding coding scheme;
modulating each of the stream blocks according to a corresponding modulation scheme;
demultiplexing the stream blocks to generate a plurality of sets of symbols, with each stream block being demultiplexed into a set of symbols;
mapping the plurality of sets of symbols into the plurality of antenna ports in accordance with a selected symbol mapping scheme; and
transmitting the plurality of sets of symbols via the corresponding antenna ports, with each set of symbols being transmitted via a subset of antenna ports, with, within each subset of antenna ports, the distance between the corresponding physical antennas being larger than the average distance among the plurality of physical antennas.

9. The method of claim 8, comprised of, when two stream blocks are transmitted via four antenna ports,
the selected antenna port mapping scheme being established such that a first antenna port is mapped to a first physical antenna, a second antenna port is mapped to a third physical antenna, a third antenna port is mapped to a second physical antenna, and a fourth antenna port is mapped to a fourth physical antenna, with the four physical antennas being aligned sequentially with equal spacing between two immediately adjacent physical antennas, and
the selected symbol mapping scheme being established such that a first stream block is mapped to the first and the second antenna ports, and a second stream block is mapped to the third and the fourth antenna ports.

10. The method of claim 8, comprised of, when two stream blocks are transmitted via four antenna ports,
the selected antenna port mapping scheme being established such that a first antenna port is mapped to a first physical antenna, a second antenna port is mapped to a second physical antenna, a third antenna port is mapped to a third physical antenna, and a fourth antenna port is mapped to a fourth physical antenna, with the four physical antennas being aligned sequentially with equal spacing between two immediately adjacent physical antennas; and
the selected symbol mapping scheme being established such that a first stream block is mapped to the first and the third antenna ports, and a second stream block is mapped to the second and the fourth antenna ports, such that the third and the fourth antenna ports having weaker channel estimates are equally distributed between the first and the second stream blocks.

11. A method for transmission, the method comprising the steps of:
demultiplexing information to be transmitted into a plurality of stream blocks;
inserting a respective cyclic redundancy check to each of the stream blocks;
encoding each of the stream blocks according to a corresponding coding scheme;
modulating each of the stream blocks according to a corresponding modulation scheme to generate a plurality of modulated symbols;
dividing the plurality of modulated symbols into a plurality of groups of modulated symbols;
selecting a subset of matrices from among six permuted versions of a selected Space Frequency Block Code matrix;
repeatedly applying the selected set of matrices to the plurality of groups of modulated symbols to generate a plurality of transmit matrices, with each matrix corresponding to a group of modulated symbols and being applied to each pair of modulated symbols from among the corresponding group of modulated symbols; and
transmitting the plurality of transmit matrices via four transmission antennas using a plurality of subcarriers, with each transmit matrix using two subcarriers.

12. The method of claim 11, comprised of the selected Space Frequency Block Code diversity matrix being a Space Frequency Block Code Cyclic Delay Diversity (SFBC-CDD) matrix, and the six permutated versions being expressed as:
$${P}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )}\end{matrix} ] , \\ {P}_{B} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] , \\ {P}_{C} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{D} = [ \begin{matrix}{S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{1} ( i ) & - {S}_{2}^{*} ( i ) \\ {S}_{2} ( i ) & {S}_{1}^{*} ( i )\end{matrix} ] , \\ {P}_{E} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{F} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] ,$$
where S₁(i) and S₂(i) are two viable symbols, i=1, 2, . . . , N, N is the number of modulated symbols in each group of modulated symbols, g=[k/2] is the group index of two subcarriers, k is the subcarrier index, and functions b₁(g) and b₂(g) are two pseudo-random phase shift vectors that are functions of the subcarrier group index g.

13. The method of claim 11, comprised of the selected Space Frequency Block Code diversity matrix being a Space Frequency Block Code Phase Switched Diversity (SFBC-PSD) matrix, and the six permutated versions being expressed as:
$${C}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{B} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{C} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{D} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{1} ( i ) & - {S}_{2}^{*} ( i ) \\ {S}_{2} ( i ) & {S}_{1}^{*} ( i )\end{matrix} ] , \\ {C}_{E} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{C} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ]$$
where S₁(i) and S₂(i) are two viable symbols, i=1, 2, . . . , N, N is the number of modulated symbols in each group of modulated symbols, k is the subcarrier index, and θ₁ and θ₂ are two fixed phase angles.

14. A method for transmission, the method comprising the steps of:
demultiplexing information to be transmitted into a plurality of stream blocks;
inserting a respective cyclic redundancy check to each of the stream blocks;
encoding each of the stream blocks according to a corresponding coding scheme;
modulating each of the stream blocks according to a corresponding modulation scheme to generate a pair of modulated symbols;
selecting a subset of matrices from among six permuted versions of a selected Space Frequency Block Code matrix;
repeatedly transmitting the pair of symbols by applying the selected set of matrices to the pairs of modulated symbols, with each matrix being transmitted at a time slot.

15. The method of claim 14, comprised of the selected Space Frequency Block Code matrix being a Space Frequency Block Code Phase Switched Diversity (SFBC-PSD) matrix, and the six permuted versions of the SFBC-PSD matrix being expressed as:
$${P}_{A} = [ \begin{matrix}{S}_{1} & - {S}_{2}^{*} \\ {S}_{2} & {S}_{1}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )}\end{matrix} ] , \\ {P}_{B} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] , \\ {P}_{C} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{D} = [ \begin{matrix}{S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{1} & - {S}_{2}^{*} \\ {S}_{2} & {S}_{1}^{*}\end{matrix} ] , \\ {P}_{E} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{F} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] ,$$
where S₁ and S₂ are the two modulated symbols, g=[k/2] is the group index of two subcarriers, k is the subcarrier index, and functions b₁(g) and b₂(g) are two pseudo-random phase shift vectors that are functions of the subcarrier group index g.

16. The transmitter of claim 14, comprised of the selected Space Frequency Block Code matrix being a Space Frequency Block Code Cyclic Delay Diversity (SFBC-CDD) matrix, and the six permuted versions of the SFBC-CDDD matrix being expressed as:
$${C}_{A} = [ \begin{matrix}{S}_{1} & - {S}_{2}^{*} \\ {S}_{2} & {S}_{1}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}}\end{matrix} ] , \\ {C}_{B} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] , \\ {C}_{C} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{D} = [ \begin{matrix}{S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{1} & - {S}_{2}^{*} \\ {S}_{2} & {S}_{1}^{*}\end{matrix} ] , \\ {C}_{E} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{F} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] ,$$
where S₁ and S₂ are two modulated symbols, k is the subcarrier index, and θ₁ and θ₂ are two fixed phase angles.

17. A transmitter, comprising:
a first demultiplexing unit demultiplexing information to be transmitted into a plurality of stream blocks;
a plurality of cyclic redundancy check insertion units inserting cyclic redundancy checks to the corresponding stream blocks;
a plurality of coding units encoding the corresponding stream blocks according to corresponding coding schemes;
a plurality of modulation units modulating the corresponding stream blocks according to corresponding modulation schemes;
a plurality of second demultiplexing units demultiplexing the corresponding stream blocks to generate a plurality of sets of symbols, with each stream block being demultiplexed into a set of symbols; and
a plurality of physical antennas connected with a plurality of antenna ports for transmitting the plurality of sets of symbols, with each set of symbols being transmitted via a subset of antenna ports, and the antenna ports having weaker channel estimates being equally distributed among the plurality of sets of antenna ports.

18. A transmitter, comprising:
a reference signal generator generating a plurality of reference signals for a plurality of physical antennas, with each reference signal corresponding to a physical antenna;
an antenna port mapping unit mapping the plurality of antenna ports to a plurality of physical antennas in accordance with a selected antenna port mapping scheme, with each antenna port corresponding to a physical antenna;
a first demultiplexing unit demultiplexing information to be transmitted into a plurality of stream blocks;
a plurality of cyclic redundancy check insertion units inserting respective cyclic redundancy checks to the corresponding stream blocks;
a plurality of coding units encoding the corresponding stream blocks according to corresponding coding schemes;
a plurality of modulation unit modulating the corresponding stream blocks according to corresponding modulation schemes;
a plurality of second demultiplexing units demultiplexing the corresponding stream blocks to generate a plurality of sets of symbols, with each stream block being demultiplexed into a set of symbols; and
a symbol mapping unit mapping the plurality of sets of symbols into the plurality of antenna ports in accordance with a selected symbol mapping scheme, with each set of symbols being transmitted via a subset of antenna ports, and within each subset of antenna ports, the distance between the physical antennas of the corresponding antenna ports being larger than the average distance among the plurality of physical antennas.

19. The transmitter of claim 18, comprised of, when two stream blocks are transmitted via four antenna ports,
the selected antenna port mapping scheme being established such that a first antenna port is mapped to a first physical antenna, a second antenna port is mapped to a third physical antenna, a third antenna port is mapped to a second physical antenna, and a fourth antenna port is mapped to a fourth physical antenna, with the four physical antennas being aligned sequentially with equal spacing between two immediately adjacent physical antennas, and
the selected symbol mapping scheme being established such that a first stream block is mapped to the first and the second antenna ports, and a second stream block is mapped to the third and the fourth antenna ports.

20. The method of claim 18, comprised of, when two stream blocks are transmitted via four antenna ports,
the selected antenna port mapping scheme being established such that a first antenna port is mapped to a first physical antenna, a second antenna port is mapped to a second physical antenna, a third antenna port is mapped to a third physical antenna, and a fourth antenna port is mapped to a fourth physical antenna, with the four physical antennas being aligned sequentially with equal spacing between two immediately adjacent physical antennas, and
the selected symbol mapping scheme being established such that a first stream block is mapped to the first and the third antenna ports, and a second stream block is mapped to the second and the fourth antenna ports, such that the third and the fourth antenna ports having weaker channel estimates are equally distributed between the first and the second stream blocks.

21. A transmitter, comprising:
a reference signal generator generating a plurality of reference signals for a plurality of physical antennas, with each reference signal corresponding to a physical antenna;
an antenna port mapping unit mapping the four antenna ports to four physical antennas in accordance with a selected antenna port mapping scheme;
a modulator modulating data to be transmitted into a plurality of modulated symbols; and
a plurality of encoding units encoding each pair of modulated symbols from among said plurality of symbols in accordance with a transmission diversity scheme to result in a plurality of 2 by 2 matrices, with each 2 by 2 matrix corresponding to each pair of modulated symbols, and the plurality of modulated symbols being transmitted via the plurality of antenna ports in accordance with a transmission matrix established by:
$$[ \begin{matrix}{T}_{11} & {T}_{12} & {T}_{13} & {T}_{14} & ⋯ & {T}_{1 , 2 M - 1} & {T}_{1 , 2 M} \\ {T}_{21} & {T}_{22} & {T}_{23} & {T}_{24} & ⋯ & {T}_{2 , 2 M - 1} & {T}_{2 , 2 M} \\ {T}_{31} & {T}_{32} & {T}_{33} & {T}_{34} & ⋯ & {T}_{3 , 2 M - 1} & {T}_{3 , 2 M} \\ {T}_{41} & {T}_{42} & {T}_{43} & {T}_{44} & ⋯ & {T}_{4 , 2 M - 1} & {T}_{4 , 2 M} \\ ⋮ & ⋮ & ⋮ & ⋮ & ⋰ & ⋮ & ⋮ \\ {T}_{2 M - 1 , 1} & {T}_{2 M - 1 , 2} & {T}_{2 M - 1 , 3} & {T}_{2 M - 1 , 4} & ⋯ & {T}_{2 M - 1 , 2 M - 1} & {T}_{2 M - 1 , 2 M - 1} \\ {T}_{2 M , 1} & {T}_{2 M , 2} & {T}_{2 M , 3} & {T}_{2 M , 4} & ⋯ & {T}_{2 M , 2 M - 1} & {T}_{2 M , 2 M}\end{matrix} ] = [ \begin{matrix}{S}_{1} & - {S}_{2}^{*} & 0 & 0 & ⋯ & 0 & 0 \\ {S}_{2} & {S}_{1}^{*} & 0 & 0 & ⋯ & 0 & 0 \\ 0 & 0 & {S}_{3} & - {S}_{4}^{*} & ⋯ & 0 & 0 \\ 0 & 0 & {S}_{4} & {S}_{3}^{*} & ⋯ & 0 & 0 \\ ⋮ & ⋮ & ⋮ & ⋮ & ⋰ & ⋮ & ⋮ \\ 0 & 0 & 0 & 0 & ⋯ & {S}_{2 M - 1} & - {S}_{2 M}^{*} \\ 0 & 0 & 0 & 0 & ⋯ & {S}_{2 M} & {S}_{2 M - 1}^{*}\end{matrix} ]$$
where M is the total number of the 2 by 2 matrices, S₁ through S_{2M-1} are the plurality of modulated symbols, Tᵢⱼ represents the symbol transmitted on the ith antenna port and the jth subcarrier or jth time slot.

22. The transmitter of claim 21, comprised of, when four modulated symbols are transmitted via four antenna ports,
the selected antenna port mapping scheme being established such that a first antenna port is mapped to a first physical antenna, a second antenna port is mapped to a third physical antenna, a third antenna port is mapped to a second physical antenna, and a fourth antenna port is mapped to a fourth physical antenna, with the four physical antennas being aligned sequentially with equal spacing between two immediately adjacent physical antennas, and
the transmission matrix being established as:
$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ {S}_{2} & {S}_{1}^{*} & 0 & 0 \\ 0 & 0 & {S}_{3} & - {S}_{4}^{*} \\ 0 & 0 & {S}_{4} & {S}_{3}^{*}\end{matrix} ]$$
where Tᵢⱼ represents the symbol transmitted on the ith antenna port and the jth subcarrier or jth time slot, S₁, S₂, S₃, and S₄ represent the first through the fourth symbols respectively.

23. The transmitter of claim 21, comprised of, when four modulated symbols are transmitted via four antenna ports,
the selected antenna port mapping scheme being established such that a first antenna port is mapped to a first physical antenna, a second antenna port is mapped to a second physical antenna, a third antenna port is mapped to a third physical antenna, and a fourth antenna port is mapped to a fourth physical antenna, with the four physical antennas being aligned sequentially with equal spacing between two immediately adjacent physical antennas, and
a selected pair of rows of the transmission matrix being exchanged and the resulted new transmission matrix being established as:
$$[ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ {T}_{41} & {T}_{42} & {T}_{43} & {T}_{44}\end{matrix} ] = [ \begin{matrix}{S}_{1} & - {S}_{2}^{*} & 0 & 0 \\ 0 & 0 & {S}_{3} & - {S}_{4}^{*} \\ {S}_{2} & {S}_{1}^{*} & 0 & 0 \\ 0 & 0 & {S}_{4} & {S}_{3}^{*}\end{matrix} ]$$
where Tᵢⱼ represents the symbol transmitted on the ith antenna port and the jth subcarrier or jth time slot, S₁, S₂, S₃, and S₄ represent the first through the fourth symbols respectively.

24. A transmitter, comprising:
a demultiplexing unit demultiplexing information to be transmitted into a plurality of stream blocks;
a plurality of cyclic redundancy check insertion units inserting respective cyclic redundancy checks to the corresponding stream blocks;
a plurality of coding units encoding the corresponding stream blocks according to corresponding coding schemes;
a plurality of modulation units modulating the corresponding stream blocks according to corresponding modulation schemes to generate a plurality of modulated symbols;
a dividing unit dividing the plurality of modulated symbols into a plurality of groups of modulated symbols;
a selection unit selecting a subset of matrices from among six permuted versions of a selected Space Frequency Block Code diversity matrix;
a transmit matrix generating unit repeatedly applying the selected set of matrices to the plurality of groups of modulated symbols to generate a plurality of transmit matrices, with each matrix corresponding to a group of modulated symbols and each matrix being applied to each pair of modulated symbols from the corresponding group of modulated symbols; and
four transmission antennas transmitting the plurality of transmit matrices using a plurality of subcarriers, with each transmit matrix using two subcarriers.

25. The transmitter of claim 24, comprised of the selected Space Frequency Block Code diversity matrix being a Space Frequency Block Code Cyclic Delay Diversity (SFBC-CDD) matrix, and the six permutated versions being expressed as:
$${P}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )}\end{matrix} ] , \\ {P}_{B} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] , \\ {P}_{C} = [ \begin{matrix}{S}_{1} ( i ) & - {S}_{2}^{*} ( i ) \\ {S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{D} = [ \begin{matrix}{S}_{1} ( i ) {e}^{{jθ}_{1} ( g )} & - {S}_{2}^{*} ( i ) {e}^{{jθ}_{1} ( g )} \\ {S}_{2} ( i ) {e}^{{jθ}_{2} ( g )} & {S}_{1}^{*} ( i ) {e}^{{jθ}_{2} ( g )} \\ {S}_{1} ( i ) & - {S}_{2}^{*} ( i ) \\ {S}_{2} ( i ) & {S}_{1}^{*} ( i )\end{matrix} ] , \\ {P}_{E} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) {e}^{{jθ}_{2} ( g )} & {S}_{1}^{*} ( i ) {e}^{{jθ}_{2} ( g )} \\ {S}_{2} ( i ) & {S}_{1}^{*} ( i )\end{matrix} ] , \\ {P}_{F} = [ \begin{matrix}{S}_{1} ( i ) {e}^{{jθ}_{1} ( g )} & - {S}_{2}^{*} ( i ) {e}^{{jθ}_{1} ( g )} \\ {S}_{1} ( i ) & - {S}_{2}^{*} ( i ) \\ {S}_{2} ( i ) & {S}_{1}^{*} ( i ) \\ {S}_{2} ( i ) {e}^{{jθ}_{2} ( g )} & {S}_{1}^{*} ( i ) {e}^{{jθ}_{2} ( g )}\end{matrix} ] ,$$
where S₁(i) and S₂(i) are two viable symbols, i=1, 2, . . . N, N is the number of modulated symbols in each group of modulated symbols, g=[k/2] is the group index of two subcarriers, k is the subcarrier index, and functions b₁(g) and b₂(g) are two pseudo-random phase shift vectors that are functions of the subcarrier group index g.

26. The transmitter of claim 24, comprised of the selected Space Frequency Block Code diversity matrix being a Space Frequency Block Code Phase Switched Diversity (SFBC-PSD) matrix, and the six permutated versions being expressed as:
$${C}_{A} = [ \begin{matrix}{S}_{1} ( i ) & - {S}_{2}^{*} ( i ) \\ {S}_{2} ( i ) & {S}_{1}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{B} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ] , \\ {C}_{C} = [ \begin{matrix}{S}_{1} ( i ) & - {S}_{2}^{*} ( i ) \\ {S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{D} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{2} ( i ) {e}^{j k {θ}_{2}} & {S}_{1}^{*} ( i ) {e}^{j ( k + 1 ) {θ}_{2}} \\ {S}_{1} ( i ) & - {S}_{2}^{*} ( i ) \\ {S}_{2} ( i ) & {S}_{1}^{*} ( i )\end{matrix} ] , \\ {C}_{E} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) {e}^{j k {θ}_{2}} & {S}_{1}^{*} ( i ) {e}^{j ( k + 1 ) {θ}_{2}} \\ {S}_{2} ( i ) & {S}_{1}^{*} ( i )\end{matrix} ] , \\ {C}_{C} = [ \begin{matrix}{S}_{1} ( i ) {e}^{j k {θ}_{1}} & - {S}_{2}^{*} ( i ) {e}^{j ( k + 1 ) {θ}_{1}} \\ {S}_{1} ( i ) & - {S}_{2}^{*} ( i ) \\ {S}_{2} ( i ) & {S}_{1}^{*} ( i ) \\ {S}_{2} ( i ) {e}^{j k {θ}_{2}} & {S}_{1}^{*} ( i ) {e}^{j ( k + 1 ) {θ}_{2}}\end{matrix} ]$$
where S₁(i) and S₂(i) are two viable symbols, i=1, 2, . . . , N, N is the number of modulated symbols in each group of modulated symbols, k is the subcarrier index, and θ₁ and θ₂ are two fixed phase angles.

27. A transmitter, comprising:
a demultiplexing unit demultiplexing information to be transmitted into a plurality of stream blocks;
a plurality of cyclic redundancy check insertion units inserting respective cyclic redundancy checks to the corresponding stream blocks;
a plurality of coding units encoding the corresponding stream blocks according to corresponding coding schemes;
a plurality of modulation units modulating the corresponding stream blocks according to corresponding modulation schemes to generate a pair of modulated symbols;
a selection unit selecting a subset of matrices from among six permuted versions of a selected Space Frequency Block Code matrix; and
four transmission antennas for repeatedly transmitting the pair of symbols by applying the selected set of matrices to the pairs of modulated symbols, with each matrix being transmitted at a time slot.

28. The transmitter of claim 27, comprised of the selected Space Frequency Block Code matrix being a Space Frequency Block Code Phase Switched Diversity (SFBC-PSD) matrix, and the six permuted versions of the SFBC-PSD matrix being expressed as:
$${P}_{A} = [ \begin{matrix}{S}_{1} & - {S}_{2}^{*} \\ {S}_{2} & {S}_{1}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )}\end{matrix} ] , \\ {P}_{B} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] , \\ {P}_{C} = [ \begin{matrix}{S}_{1} & - {S}_{2}^{*} \\ {S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{D} = [ \begin{matrix}{S}_{1} {e}^{{jθ}_{1} ( g )} & - {S}_{2}^{*} {e}^{{jθ}_{1} ( g )} \\ {S}_{2} {e}^{{jθ}_{2} ( g )} & {S}_{1}^{*} {e}^{{jθ}_{2} ( g )} \\ {S}_{1} & - {S}_{2}^{*} \\ {S}_{2} & {S}_{1}^{*}\end{matrix} ] , \\ {P}_{E} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} {e}^{{jθ}_{2} ( g )} & {S}_{1}^{*} {e}^{{jθ}_{2} ( g )} \\ {S}_{2} & {S}_{1}^{*}\end{matrix} ] , \\ {P}_{F} = [ \begin{matrix}{S}_{1} {e}^{{jθ}_{1} ( g )} & - {S}_{2}^{*} {e}^{{jθ}_{1} ( g )} \\ {S}_{1} & - {S}_{2}^{*} \\ {S}_{2} & {S}_{1}^{*} \\ {S}_{2} {e}^{{jθ}_{2} ( g )} & {S}_{1}^{*} {e}^{{jθ}_{2} ( g )}\end{matrix} ] ,$$
where S₁ and S₂ are the two modulated symbols, g=[k/2] is the group index of two subcarriers, k is the subcarrier index, and functions b₁(g) and b₂(g) are two pseudo-random phase shift vectors that are functions of the subcarrier group index g.

29. The transmitter of claim 27, comprised of the selected Space Frequency Block Code matrix being a Space Frequency Block Code Cyclic Delay Diversity (SFBC-CDD) matrix, and the six permuted versions of the SFBC-CDDD matrix being expressed as:
$${C}_{A} = [ \begin{matrix}{S}_{1} & - {S}_{2}^{*} \\ {S}_{2} & {S}_{1}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}}\end{matrix} ] , \\ {C}_{B} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] , \\ {C}_{C} = [ \begin{matrix}{S}_{1} & - {S}_{2}^{*} \\ {S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{D} = [ \begin{matrix}{S}_{1} {e}^{j k {θ}_{1}} & - {S}_{2}^{*} {e}^{j ( k + 1 ) {θ}_{1}} \\ {S}_{2} {e}^{j k {θ}_{2}} & {S}_{1}^{*} {e}^{j ( k + 1 ) {θ}_{2}} \\ {S}_{1} & - {S}_{2}^{*} \\ {S}_{2} & {S}_{1}^{*}\end{matrix} ] , \\ {C}_{E} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} {e}^{j k {θ}_{2}} & {S}_{1}^{*} {e}^{j ( k + 1 ) {θ}_{2}} \\ {S}_{2} & {S}_{1}^{*}\end{matrix} ] , \\ {C}_{F} = [ \begin{matrix}{S}_{1} {e}^{j k {θ}_{1}} & - {S}_{2}^{*} {e}^{j ( k + 1 ) {θ}_{1}} \\ {S}_{1} & - {S}_{2}^{*} \\ {S}_{2} & {S}_{1}^{*} \\ {S}_{2} {e}^{j k {θ}_{2}} & {S}_{1}^{*} {e}^{j ( k + 1 ) {θ}_{2}}\end{matrix} ] ,$$
where S₁ and S₂ are two modulated symbols, k is the subcarrier index, and θ₁ and θ₂ are two fixed phase angles.
